(19) United States
(12) Patent Application Publication
(10) Pub. No.: US 2021/0158068 A1
(43) Pub. Date: May 27, 2021

(54) Operation Circuit of Convolutional Neural Network

(71) Applicants: Gree Electric Appliances (Wuhan) Co., Ltd, Development Zone (CN); Gree Electric Appliances, Inc. of Zhuhai, Zhuhai, Guangdong (CN)

(72) Inventors: Heng CHEN, Zhuhai, Guangdong (CN); Dongbo YI, Zhuhai, Guangdong (CN); Li FANG, Zhuhai, Guangdong (CN)

(21) Appl. No.: 16/627,674

(22) PCT Filed: Aug. 9, 2018
(86) PCT No.: PCT/CN2018/099596

§ 371 Date: Dec. 30, 2019

(30) Foreign Application Priority Data
Oct. 19, 2017 (CN) CN 201710983547.1

(51) Int. Cl. G06K 9/00; G06T 1/60; G06K 9/46; G06K 9/62; G06N 3/04; G06N 3/063

(52) U.S. Cl. CPC G06K 9/00986; G06T 1/60; G06K 9/4604; G06N 3/063; G06K 9/629; G06N 3/04; G06K 9/6217

(57) ABSTRACT

An operation circuit of a convolutional neural network is provided. The circuit includes: an external memory configured to store an image to be processed, a direct access element connected with the external memory and configured to read the image to be processed and transmit this image to a control element, the control element connected with the direct access element and configured to store the image to be processed into an internal memory, the internal memory connected with the control element and configured to cache the image to be processed, and at least one operation element connected with the internal memory and configured to read the image to be processed from the internal memory and implement convolution and pooling operations. Through the circuit, the technical problem that a large system bandwidth is occupied due to a large amount of the convolution operation of the convolutional neural network is solved.

### CROSS-REFERENCE TO RELATED APPLICATIONS

The present disclosure claims priority of Chinese Patent Application No. 201710983547.1, filed to China Patent Office on Oct. 19, 2017. Contents of the present disclosure are hereby incorporated by reference in entirety of the Chinese Patent Application.

### TECHNICAL FIELD

The present disclosure relates to the field of image processing, and in particular to an operation circuit of a convolutional neural network.

### BACKGROUND

A Convolutional Neural Network (CNN), as one of artificial neural networks, has become a research hotspot in the field of speech analysis and image identification at present. The CNN is a multi-layer neural network, each layer consists of multiple two-dimensional planes, and each plane is convolved from different convolution kernels. An image layer after convolution is subjected to pooling to generate a feature map, and the feature map is transmitted to a network of a next layer.

The CNN has a great amount of convolution operation, and each layer of the CNN is subjected to the convolution operation. Multiple layers of convolution kernels and multiple planes of convolution are used for executing an identification operation. For a general Central Processing Unit (CPU) and a general Graphic Processing Unit (GPU), this type of convolution operation takes quite a long time. Furthermore, the convolution of different layers and different planes may occupy a tremendous system bandwidth and have a very high requirement on performance of a system.

As to the problem mentioned above, no effective solution has been provided yet.

### SUMMARY

At least some embodiments of the present disclosure provide an operation circuit of a convolutional neural network, so as at least to partially solve a technical problem that a large system bandwidth is occupied due to a great amount of convolution operation of a convolutional neural network.

In an embodiment of the present disclosure, an operation circuit of a convolutional neural network is provided, including: an external memory configured to store an image to be processed, a direct access element connected with the external memory and configured to read the image to be processed and transmit the image to be processed to a control element, the control element connected with the direct access element and configured to store the image to be processed into an internal memory, the internal memory connected with the control element and configured to cache the image to be processed, and at least one operation element connected with the internal memory and configured to read the image to be processed from the internal memory and implement convolution and pooling operations.

Optionally, the circuit includes at least two operation elements.

Optionally, when connection with a cascade structure is taken between the at least two operation elements, data of a nth layer is cached into the internal memory after subjected to the convolution and pooling operations of a nth operation element, a (n+1)th operation element takes out the image to be processed after the operation and implements the convolution and pooling operations of a (n+1) layer, and n is a positive integer.

Optionally, when connection with a parallel structure is taken between the at least two operation elements, the at least two operation elements respectively process part of the image to be processed, and implement parallel convolution and pooling operations with an identical convolution kernel.

Optionally, when the connection with the parallel structure is taken between the at least two operation elements, the at least two operation elements respectively extract different features from the image to be processed, and implement the parallel convolution and pooling operations with different convolution kernels.

Optionally, when there are two operation elements, the two operation elements respectively extract outline information and detailed information of the image to be processed.

Optionally, each of the at least one operation element includes a convolution operation element, a pooling operation element, a buffer element and a buffer control element.

Optionally, the convolution operation element is configured to implement convolution operation on the image to be processed to acquire a convolution result and transmit the convolution result to the pooling operation element, the pooling operation element is connected with the convolution operation element and configured to implement pooling operation on the convolution result to acquire a pooling result and store the pooling result into the buffer element, and the buffer control element is configured to store the pooling result into the internal memory through the buffer element or store into the external memory through the direct access element.

Optionally, the external memory includes at least one of the followings: a double data rate synchronous dynamic random access memory and a synchronous dynamic random access memory.

Optionally, the internal memory includes a static random access memory array (SRAM ARRAY), the SRAM ARRAY includes multiple static memories, and each static memory is configured to store different data.

Through the at least some embodiment of the present disclosure, the external memory is taken to store the image to be processed, the direct access element reads the image to be processed, and transmits the image to be processed to the control element, the control element stores the image to be processed into the internal memory, the internal memory caches the image to be processed, and the operation element reads the image to be processed from the internal memory and implements convolution and pooling operations. The image to be processed is cached through the internal memory, accordingly a purpose of reading one frame of image from the external memory during the convolution operation is achieved, without reading data of the frame of image repeatedly. In this way, a technical effect of effectively saving the system bandwidth is achieved, and accordingly the technical problem that the large system bandwidth is occupied due to the great amount of convolution operation of the convolutional neural network is solved.

### BRIEF DESCRIPTION OF THE DRAWINGS

The accompanying drawings described herein are used for providing a further understanding of the present disclosure, and constitute a part of the present disclosure, and exemplary embodiments of the present disclosure and the description thereof are used for explaining the present disclosure, but do not constitute improper limitations to the present disclosure. In the drawings:

FIG. 1 is a structural schematic diagram of an optional operation circuit of a convolutional neural network according to an embodiment of the present disclosure.

FIG. 2 is a structural schematic diagram of another optional operation circuit of a convolutional neural network according to an embodiment of the present disclosure.

FIG. 3 is a structural schematic diagram of still another optional operation circuit of a convolutional neural network according to an embodiment of the present disclosure.

FIG. 4 is a structural schematic diagram of still another optional operation circuit of a convolutional neural network according to an embodiment of the present disclosure.

### DETAILED DESCRIPTION

In order to make the solutions of the present disclosure better understood by those skilled in the art, the technical solutions in the embodiments of the present disclosure will be clearly and completely described below in combination with drawings in the embodiments of the present disclosure. It is apparent that the described embodiments are not all embodiments but part of embodiments of the present disclosure. All other embodiments obtained by those of ordinary skill in the art on the basis of the embodiments in the present disclosure without creative work shall fall within the scope of protection of the present disclosure.

It is to be noted that terms “first”, “second” and the like in the specification, claims and drawings of the present disclosure are adopted not to describe a specific sequence but to distinguish similar objects. It should be understood that data used in such a way may be interchangeable where appropriate, such that the embodiments of the present disclosure described here may be implemented in an order other than those illustrated or described here. In addition, terms “include” and “have” and any variations thereof are intended to cover nonexclusive inclusions. For example, a process, a method, a system, a product or a device including a series of operations or elements is not limited to the operations or elements which are expressly listed, but may alternatively further include operations or elements which are not expressly listed or alternatively further include other operations or elements intrinsic to the process, the method, the product or the device.

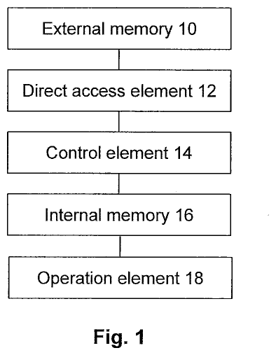

In an embodiment of the present disclosure, a structure embodiment of an operation circuit of a Convolutional Neural Network (CNN) is provided. FIG. 1 is a structural schematic diagram of an operation circuit of a convolutional neural network according to an embodiment of the present disclosure. As shown in FIG. 1, the operation circuit of the convolutional neural network includes an external memory 10, a direct access element 12, a control element 14, an internal memory 16 and an operation element 18.

And the external memory 10 is configured to store an image to be processed, the direct access element 12 is connected with the external memory 10 and configured to read the image to be processed and transmit the image to be processed to the control element, the control element 14 is connected with the direct access element 12 and configured to store the image to be processed into the internal memory 16, the internal memory 16 is connected with the control element 14 and configured to cache the image to be processed, and the operation element 18 is connected with the internal memory 16 and configured to read the image to be processed from the internal memory 16 and implement convolution and pooling operations.

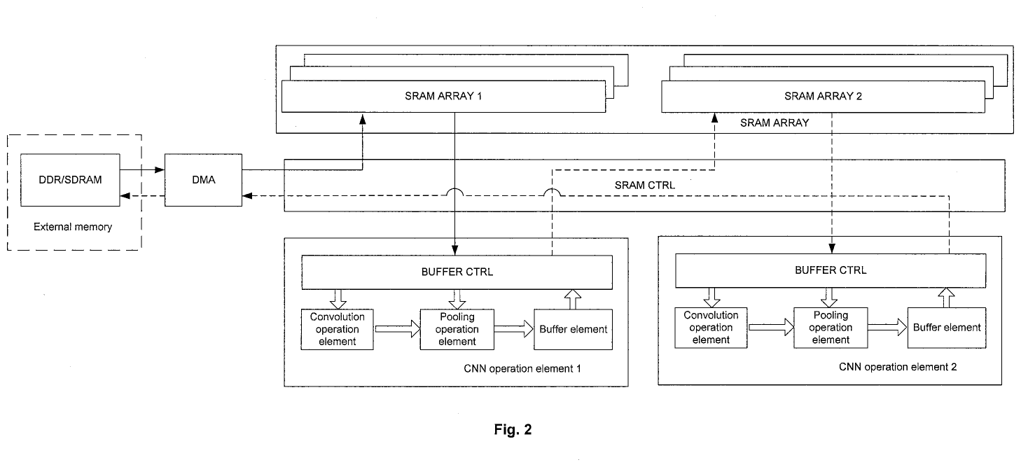

As shown in FIG. 2, configuration of two CNN operation elements (namely, the abovementioned operation element 18) is taken as an example to explain. The image to be processed is stored into the external memory, and a Direct Memory Access (DMA) (namely, the abovementioned direct access element 12) reads the image to be processed (for example, reads according to a row order of the image to be processed), and transmit the image to be processed to a Static Random Access Memory Control (SRAM CTRL) component, namely, the abovementioned control element 14. The SRAM CTRL likewise stores the image to be processed into a Static Random Access Memory Array (SRAM ARRAY) (namely, the abovementioned internal memory 16) according to the row order. It is assumed that the SRAM ARRAY 1 in FIG. 2 consists of three SRAMs, and a memory capacity of each SRAM is a row of one image (take a 1920*1080 image as an example, the memory capacity is 1920Byte). The three SRAMs respectively store data of a Nth row, a (N+1)th row and a (N+2)th row. When the three rows of data are replaced completely, a BUFFER CTRL (namely, a subsequent buffer control element) of a CNN operation element (namely, the abovementioned operation element 18) synchronously reads the three rows of data, and stores as a 3*3 array for the convolution operation to acquire a onvolution result. The convolution result is transmitted to a pooling operation element for the pooling operation to acquire a pooling result, and the pooling result is stored into the SRAM ARRAY through a buffer element or stored into the external memory through the DMA.

With the adoption of the operation circuit of the convolutional neural network of the embodiment, row image data cached by the SRAM ARRAY makes the convolution operation implemented by reading one frame of image from the external memory, without reading several rows of data of this frame of image repeatedly. In this way, a system bandwidth is effectively saved, the CNN operation element may complete one time of convolution operation and pooling operation within a cycle, and accordingly a calculating speed of the convolutional neural network is greatly improved.

In this embodiment of the present disclosure, the external memory is taken to store the image to be processed, the direct access element reads the image to be processed according to the row order, and transmits the the image to be processed to the control element, the control element stores the image to be processed into the internal memory, the internal memory caches the image to be processed, and the operation element reads the image to be processed from the internal memory and implements convolution and pooling operations. The image to be processed is cached through the internal memory, accordingly a purpose of reading one frame of image from the external memory during the convolution operation is achieved, without reading the image to be processed of the frame of image repeatedly. In this way, a technical effect of effectively saving the system bandwidth is achieved, and accordingly the technical problem that the large system bandwidth is occupied due to the great amount of convolution operation of the convolutional neural network is solved.

Optionally, the circuit includes at least two operation elements 18.

In the operation circuit of the convolutional neural network of the embodiment, there are at least two CNN operation elements (namely, the abovementioned operation element 18), and the at least two operation elements implement cascade connection or parallel connection according to actual need, so as to reduce the system bandwidth and improve a calculating speed.

Optionally, when connection with a cascade structure is taken between the at least two operation elements, data of a nth layer is cached into the internal memory after subjected to the convolution and pooling operations of a nth operation element, a (n+1)th operation element takes out the image to be processed after the operation and implements convolution and pooling operations of a (n+1) layer, and n is a positive integer.

In the convolutional neural network, a multi-layer cascade neuronal structure is often taken. When at least two layers of network structure is taken, a structure in cascade connection with each CNN operation element effectively reduces the system bandwidth and improve the calculating speed. If one CNN operation element is taken, during convolution of an image of a first layer, the image needs to be read from the external memory, stored in the SRAM ARRAY and stored back to the external memory after subjected to the convolution and pooling operations. During the convolution of a second layer, the processed image in the first layer needs to be read from the external memory, and stored back to the external memory after subjected to the convolution and pooling operations.

The 1920*1080 image is taken as an example, the system bandwidth consumed by two layers of convolution operations is 1920*1080*4 (two-read two-write) 8 MB. While when the cascade structure of the present disclosure is taken, as shown in FIG. 2, data of the image of the first layer is stored into an SRAM ARRAY 1 first from the external memory through the DMA along a solid arrow, and enters into a CNN operation element 1 for calculation. The processed image is not stored back to the external memory but stored into an SRAM ARRAY 2 along the solid arrow, and similarly sent to a CNN operation element 2 after subjected to buffering for the convolution and pooling operations. The image to be processed after being processed in the second layer is stored back to the external memory. A system bandwidth of the structure is 1920*1080*2 (one-read one-write) 4 MB, thereby reducing half of the bandwidth. Moreover, the two CNN operation elements work synchronously, and time of completely processing two layers of data is equal to time of processing one layer by one CNN operation element. Therefore, the calculating speed is doubled.

Optionally, when connection with a parallel structure is taken between the at least two operation elements, the at least two operation elements respectively process part of the image to be processed, and implement parallel convolution and pooling operation with an identical convolution kernel.

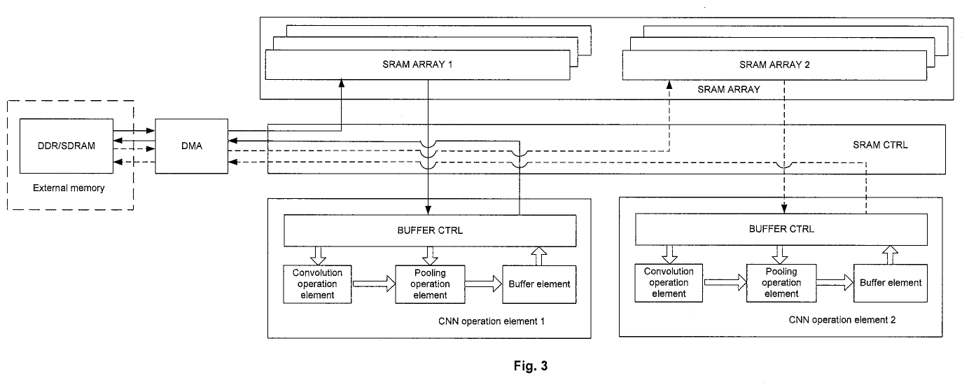

As shown in FIG. 3, two CNN operation elements are still taken as an example to explain, the parallel structure of the two CNN operation elements provided in this embodiment processes an identical frame of image in parallel to improve the calculating speed. The frame of image is divided into two parts including an upper part and a lower part. The upper part of the image is stored into the SRAM ARRAY 1 through the DMA along the solid arrow and subjected to the convolution operation of the CNN operation element 1, and a processing result is stored back to the external memory. Meanwhile, the lower part of the image is stored into the SRAM ARRAY 2 through the DMA along the solid arrow and subjected to the convolution operation of the CNN operation element 2, and a processed result is stored back to the external memory. With the adoption of the parallel structure of the two CNN operation elements, the calculating speed is doubled.

Optionally, when the connection with the parallel structure is taken between the at least two operation elements, the at least two operation elements respectively extract different features on the image to be processed, and implement the parallel convolution and pooling operations with different convolution kernels.

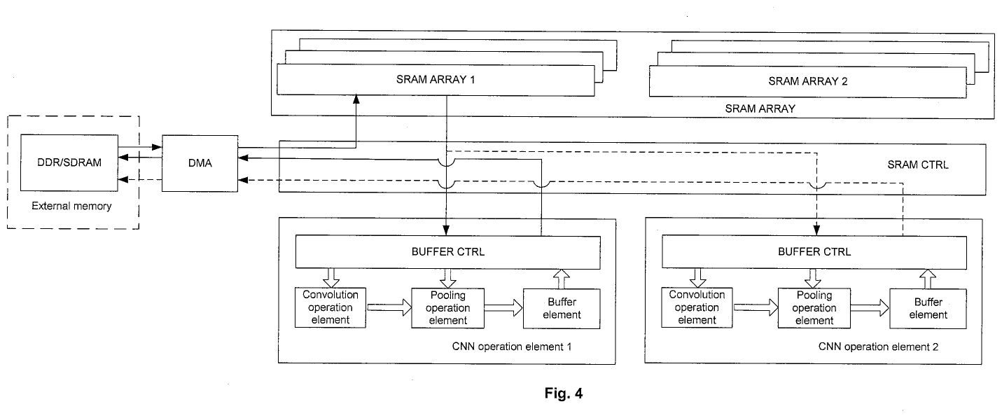

In the CNN, a mode of multi-kernel and multi-plane convolution is often taken, the convolution in presence of different convolution kernels is taken for the identical frame of image, to extract the different features. The parallel structure of the CNN is applied to such a scene as well. As shown in FIG. 4, the two CNN operation elements are taken as an example to explain, the CNN operation element 1 takes a convolution kernel coefficient, and the CNN operation element 2 takes another convolution kernel coefficient. One frame of image is read into the SRAM ARRAY 1 through the DMA, and sent to the CNN operation element 1 and the CNN operation element 2 at the same time. Two kinds of convolution operations are implemented synchronously, and the two frames of processed images are stored back to the external memory. The bandwidth of the structure is 1920*1080*6 (one-read two-write) 6 MB. Compared with one CNN operation element, the system bandwidth is reduced for 25%, and the calculating speed is doubled.

Optionally, when there are two operation elements, the two operation elements respectively extract outline information and detailed information of the image to be processed.

And one operation element extracts the outline information from the image to be processed through similar two-dimensional sampling, and another operation element extracts the detailed information from the image to be processed through the similar two-dimensional sampling. The similar two-dimensional sampling is characterized in that the detailed information or the outline information contained in images with different resolutions is different generally. An image with a large size (namely, the image having a large resolution) has a plenty of detailed information, while an image with a small size (namely, the image having a small resolution) has comprehensive outline information generally, for example, a leaf. The image having the large resolution has clear vein details of the leaf generally, while the image having the small resolution has a plenty of outline information of the leaf. For the images having different resolutions, detail sampling of the image is taken to generate a two-dimensional function f(x,y) for storage. And x,y indicates a position of the image, and f(x,y) indicates the detailed information.

Optionally, the operation element 18 includes a convolution operation element, a pooling operation element, a buffer element and a buffer control element.

Optionally, the convolution operation element is configured to implement the convolution operation on the image to be processed to acquire a convolution result and transmit the convolution result to the pooling operation element. The pooling operation element is connected with the convolution operation element and configured to implement the pooling operation on the convolution result to acquire a pooling result and store the pooling result into the buffer element. And the buffer control element is configured to store the pooling result into the internal memory through the buffer element or store into the external memory through the direct access element.

Optionally, the external memory includes at least one of the followings: a double data rate synchronous dynamic random access memory (DDR SDRAM) and a synchronous dynamic random access memory (SDRAM).

And the external memory consists of the SDRAM or the DDR SDRAM, with the great memory capacity. Furthermore, the external memory is configured to store one frame or several frames of images.

Optionally, the internal memory includes the SRAM ARRAY, the SRAM ARRAY includes multiple SRAMs, and each SRAM is configured to store different data.

And SRAM ARRAY is an internal memory element having a small memory capacity and configured to cache the image data and provide row data and line data to the convolution operation.

The operation circuit of the convolutional neural network provided in an optional embodiment of the present disclosure includes the SRAM ARRAY, SRAM CRTL Logic, the CNN operation elements, the DMA and the external memory (DDR/SDRAM). The CNN operation element consists of four components, including the convolution operation element, the pooling operation element, an output buffer element and a buffer controller (BUFFER CTRL). A case that there are two CNN operation elements is taken as an example, when the two CNN operation elements take the cascade structure, the image to be processed of the first layer is cached to the SRAM after processed by the CNN operation element 1, taken out by the CNN operation element 2 for convolution and pooling operations of the second layer, and stored back to the external memory (DDR/SDRAM). Compared with a system architecture of one CNN operation element, half of the system bandwidth is reduced, and the calculating speed is doubled. When the two CNN operation elements take the cascade structure, the two CNN operation elements respectively process an upper half and a lower half of the identical image with the identical convolution kernel, and parallel operation is implemented. Compared with the system architecture of the one CNN operation element, the calculating speed is doubled. When taking the cascade structure, the two CNN operation elements implement the parallel operation with the different convolution kernels to extract the different features from the identical image, in this way the system bandwidth is reduced for 25%, and the calculating speed is doubled.

The sequence numbers of the abovementioned embodiment of the present disclosure are for the convenience of description, and do not imply the preference among the embodiments.

In the abovementioned embodiments of the present disclosure, each embodiment is described with its emphasis. A portion not detailed in some embodiment may be referred to related description of other embodiments.

In some embodiments provided by the present disclosure, it should be understood that the technical contents disclosed may be implemented in another manner. The apparatus embodiment described above is schematic, and for example, division of the elements is logic function division, and other division manners may be adopted during practical implementation. For example, multiple elements or components may be combined or integrated into another system, or some features may be neglected or not executed. In addition, coupling, or direct coupling or communication connection between each displayed or discussed component may be in indirect coupling or communication connection, implemented through some interfaces, of the elements or components, and may be electrical or adopt other forms.

The elements described as separate parts may or may not be physically separated, and parts displayed as elements may or may not be physical elements, and namely may be located in the same place, or may also be distributed to multiple network elements. Part or all of the elements may be selected to achieve the purpose of the solutions of the embodiments according to practical need.

In addition, each function element in each embodiment of the present disclosure may be integrated into a processing element, each element may also exist independently and physically, and at least two elements may also be integrated into a element. The abovementioned integrated element may be achieved in a hardware form, and may also be achieved in form of software function element.

When being achieved in form of software function element and sold or used as an independent product, the integrated element may also be stored in a computer-readable storage medium. Based on such an understanding, the technical solutions of the present disclosure substantially or parts making contributions to the conventional art or all or part of the technical solutions may be embodied in form of software product, and the computer software product is stored in a storage medium, including a plurality of instructions configured to enable a computer device (which may be a personal computer, a server, a network device or the like) to execute all or part of the steps of the method in each embodiment of the present disclosure. The abovementioned storage medium may include: various media capable of storing program codes, such as a U disk, a Read-Only Memory (ROM), a Random Access Memory (RAM), a mobile hard disk, a magnetic disk or an optical disk.

The above are exemplary embodiments of the present disclosure. It should be pointed out that those of ordinary skill in the art may further make several improvements and modifications without departing from the principle of the present disclosure. These improvements and modifications should also be regarded as the scope of protection of the present disclosure.

What is claimed is:

1. An operation circuit of a convolutional neural network, comprising:
an external memory, configured to store an image to be processed;
a direct access element, connected with the external memory, and configured to read the image to be processed and transmit the image to be processed to a control element;
the control element, connected with the direct access element, and configured to store the image to be processed into an internal memory;
the internal memory, connected with the control element, and configured to cache the image to be processed; and
at least one operation element, connected with the internal memory, and configured to read the image to be processed from the internal memory and implement convolution and pooling operations.

2. The circuit as claimed in claim 1, wherein the circuit comprises at least two operation elements.

3. The circuit as claimed in claim 2, wherein when connection with a cascade structure is taken between the at least two operation elements, data of a nth layer is cached into the internal memory after subjected to the convolution and pooling operations of a nth operation element, a (n+1)th operation element takes out the image to be processed after the operation and implements the convolution and pooling operations of a (n+1) layer, wherein n is a positive integer.

4. The circuit as claimed in claim 2, wherein when connection with a parallel structure is taken between the at least two operation elements, and the at least two operation elements respectively process part of the image to be processed, and implement parallel convolution and pooling operations with an identical convolution kernel.

5. The circuit as claimed in claim 2, wherein when the connection with the parallel structure is taken between the at least two operation elements, the at least two operation elements respectively extract different features from the image to be processed, and implement the parallel convolution and pooling operations with different convolution kernels.

6. The circuit as claimed in claim 2, wherein when the circuit comprises two operation elements, the two operation elements respectively extract outline information and detailed information from the image to be processed.

7. The circuit as claimed in claim 1, wherein each of the at least one operation element comprises a convolution operation element, a pooling operation element, a buffer element and a buffer control element.

8. The circuit as claimed in claim 7, wherein
the convolution operation element, configured to implement the convolution operation on the image to be processed to acquire a convolution result and transmit the convolution result to the pooling operation element;
the pooling operation element, connected with the convolution operation element, and configured to implement the pooling operation on the convolution result to acquire a pooling result and store the pooling result into the buffer element; and
the buffer control element, configured to store the pooling result into the internal memory through the buffer element or store into the external memory through the direct access element.

9. The circuit as claimed in claim 1, wherein the external memory comprises at least one of the followings: a double data rate synchronous dynamic random access memory and a synchronous dynamic random access memory.

10. The circuit as claimed in claim 1, wherein the internal memory comprises a static random access memory array, the static random access memory array comprises a plurality of static random access memories, and each static random access memory is configured to store different data.
